(19) United States
(12) Patent Application Publication
(10) Pub. No.: US 2018/0152994 A1
(43) Pub. Date: May 31, 2018

(54) Microwave Oven Turntable Stabilizer Device

(71) Applicant: Edward Hare, Long Beach, CA (US)

(72) Inventor: Edward Hare, Long Beach, CA (US)

(21) Appl. No.: 15/362,791

(22) Filed: Nov. 28, 2016

(51) Int. Cl. H05B 6/64; F16B 7/10

(52) U.S. Cl. CPC H05B 6/6408; E04G 25/06; F16B 7/105

(57) ABSTRACT

A microwave oven turntable stabilizer device for stabilizing a glass turntable of a microwave oven is provided. The device comprises a tubular outer support member having a first end and a second end and an inner support member having a first end and a second end. The second end of the inner support member is slidably receivable within the first end of the outer support member. A spring mechanism is mounted between the second end of the outer support member and the second end of the inner support member with the spring mechanism biasing the inner support member in a general direction away from and out of the outer support member therein upon the combined outer support member and inner support member being positioned between the microwave turntable and the ceiling surface of the microwave, the microwave turntable is stabilized preventing movement, noise, and breakage of the microwave turntable.

### CLAIM OF PRIORITY

This patent application claims priority under 35 USC 119 (e) (1) from U.S. Provisional Patent Application Ser. No. 62/260,401 filed Nov. 27, 2015, of common inventorship herewith entitled, “Microwave Oven Turntable Stabilizer,” which is incorporated herein by reference as though the same were set forth in its entirety.

### FIELD OF THE INVENTION

The present invention pertains to the field of kitchen appliances, and more specifically to the field of microwave accessories.

### BACKGROUND OF THE INVENTION

Human beings have an age old love for travel and adventure. New countries were settled by dreamers, wanderers and outcasts who traveled across oceans and wilderness to settle and build new civilizations and lives. Today people can explore continents in climate controlled comfort yet still imagine the hardships of their ancestors. Modern travelers retrace routes of wagon trains across prairie lands, view steel rails laid a multitude of workers, traverse mountain ranges in easy comfort, and cruise languidly through waterways. The thrill of travel and the open road is a captivating pastime whether traveling by means of an interstate highway, a two lane blacktop or a continuous waterway.

Even a deluxe RV or recreational vehicle, travel trader, or boat that is equipped with all the comforts of home is subject to minor annoyances simply because it is a vehicle that moves or rocks. With such uncontrollable movement, coffee gets spilled, loose items fall, and contents shift. Bottles in a refrigerator may fall and roll. Clothes in a closet work their way off hangers as the hangers dislodge a closet rod with quick skill of an escape artist. Just as boaters go to ingenious lengths to secure all loose gear aboard a vessel, an RV owner also battens down items prior to travel in anticipation of what the motion of the road may work loose. A glass turntable in a microwave oven is an item that works its way loose, making a racket of noise and eventually breaking in several pieces.

The prior art has put forth several designs for microwave accessories. Among these are:

U.S. Pat. No. 3,880,394 to Warren R. Wisecarver describes a bracing device containing a steel tube with a rubber covered foot at one end thereof, which tube has a rectangular cross section. A sleeve is welded inside of the tube and a threaded rod is extended through the sleeve. The inner end of the threaded rod has a square washer slidably fitting into the interior of the tube so as to prevent the rotation of the threaded rod. On the outer end of the threaded rod is another rubber covered foot used for bracing. For adjusting the length of the brace, a nut is provided on the threaded rod adjacent the open end of the tube, which nut has a hexagonal portion and a cylindrical portion, and an enlarged disk at each end for manually turning of the nut. A captive wrench is permanently on the nut. The hexagonal opening on the captive wrench fits over the hexagonal portion of the nut but is freely movable over the reduced cylindrical portion of the nut whereby the wrench can be located on the hexagonal portion of the nut in any selected position for conveniently turning the nut in restricted space for changing the length of the brace.

U.S. Pat. No. 3,469,870 to Homer A. Barkus describes a telescopically adjustable shaft which is engaged and locked at any selected position on an indexing element by the pin and notch type structure, but with an added advantage that the indexing element is rotatable in an outer casing which fully encloses the mechanism. A combined rotary and axial motion is used to lock and unlock the adjustable shaft, and frictional drag means is used to hold the indexing element against rotation during the locking and unlocking, while allowing the interlocked elements slightly restrained rotation within the casing. To facilitate location of the concealed indexed positions, the indexing notches have inclined entry portions which guide the locking pin on the adjustable shaft portion of the structure. The simple mechanism is completely enclosed but is readily accessible by removing one end cap from the casing.

U.S. Pat. No. 2,806,723 to Thomas H Fairclough describes an improved telescopic support useful for extensible table legs, article stands, ironing boards, and the like, where height adjustment combined with firm support are desired. In another aspect, the telescopic support pertains to a support which is useful as a temporary prop such as supporting an automobile hood incident to servicing. More particularly, the telescopic support relates to a novel locking device structure which includes means for locking the telescopic support in any desired position and which can be readily released to permit adjustment of the support.

None of these prior art references describe the present invention.

### SUMMARY OF THE INVENTION

It is an object of the present invention to provide an effective device for stabilizing the glass turntable of a microwave oven in a recreational vehicle or a cruising boat and thus eliminate movement, noise and breakage.

The present invention is a microwave oven turntable stabilizer device for stabilizing a glass turntable of a microwave oven. The microwave oven has a ceiling surface. The microwave oven turntable stabilizer device comprises a tubular outer support member having a first end and a second end and an inner support member having a first end and a second end. The second end of the inner support member is slidably receivable within the first end of the outer support member. A spring mechanism is mounted between the second end of the outer support member and the second end of the inner support member with the spring mechanism biasing the inner support member in a general direction away from and out of the outer support member. Wherein upon the combined outer support member and inner support member being positioned between the microwave turntable and the ceiling surface of the microwave, the microwave turntable is stabilized preventing movement, noise, and breakage of the microwave turntable.

In addition, the present invention includes a method for stabilizing a glass turntable of a microwave oven. The microwave oven has a ceiling surface. The method comprises providing a tubular outer support member having a first end and a second end, providing an inner support member having a first end and a second end, sliding the second end of the inner support member into the first end of the outer support member, mounting a spring mechanism between the second end of the outer support member and the second end of the inner support member, biasing the inner support member in a general direction away from and out of the outer support member, positioning the combined outer support member and inner support member between the microwave turntable and the ceiling surface of the microwave, stabilizing the microwave turntable, and preventing movement, noise, and breakage of the microwave turntable.

The present invention further includes a microwave oven turntable stabilizer device for stabilizing a glass turntable of a microwave oven. The microwave oven has a ceiling surface. The microwave oven turntable stabilizer device comprises a tubular outer support member having a first end and a second end and an inner support member having a first end and a second end. The second end of the inner support member is slidably receivable within the first end of the outer support member. A compression spring mechanism is mounted between the second end of the outer support member and the second end of the inner support member with the spring mechanism biasing the inner support member in a general direction away from and out of the outer support member. A pair of vertically oriented, aligned opposite slots are formed in the outer support member nearingly adjacent the first end of the outer support member. A cross rod extends through the inner support member and the pair of slots and extends beyond an outer surface of the outer support member wherein pressing down on the rod forces the inner support member against the bias of the spring mechanism. Upon the combined outer support member and inner support member being positioned between the microwave turntable and the ceiling surface of the microwave, the microwave turntable is stabilized preventing movement, noise, and breakage of the microwave turntable.

### BRIEF DESCRIPTION OF THE DRAWINGS

FIG. 1 is a perspective view illustrating a microwave oven turntable stabilizer device, constructed in accordance with the present invention, showing an outer support member, an inner support member, and a spring mechanism biasing the inner support member in a general direction away from the outer support tube.

FIG. 2 is an elevational front view illustrating the microwave oven turntable stabilizer device, constructed in accordance with the present invention.

FIG. 3 is a top plan view illustrating the microwave oven turntable stabilizer device of FIG. 2, constructed in accordance with the present invention.

FIG. 4 is an elevational side view illustrating the microwave oven turntable stabilizer device of FIG. 2, constructed in accordance with the present invention.

FIG. 5 is a sectional front view illustrating the microwave oven turntable stabilizer device of FIG. 2, constructed in accordance with the present invention.

FIG. 6 is an exploded front view illustrating the microwave oven turntable device of FIG. 2, constructed in accordance with the present invention.

FIG. 7 is an elevational front view illustrating another embodiment of the microwave oven turntable stabilizer device, constructed in accordance with the present invention.

FIG. 8 is a top plan view illustrating the microwave oven turntable stabilizer device of FIG. 7, constructed in accordance with the present invention.

FIG. 9 is an elevational side view illustrating the microwave oven turntable stabilizer device of FIG. 7, constructed in accordance with the present invention.

FIG. 10 is a perspective view illustrating the microwave oven turntable device, constructed in accordance with the present invention, with the device installed in between a microwave tray and ceiling of a microwave oven.

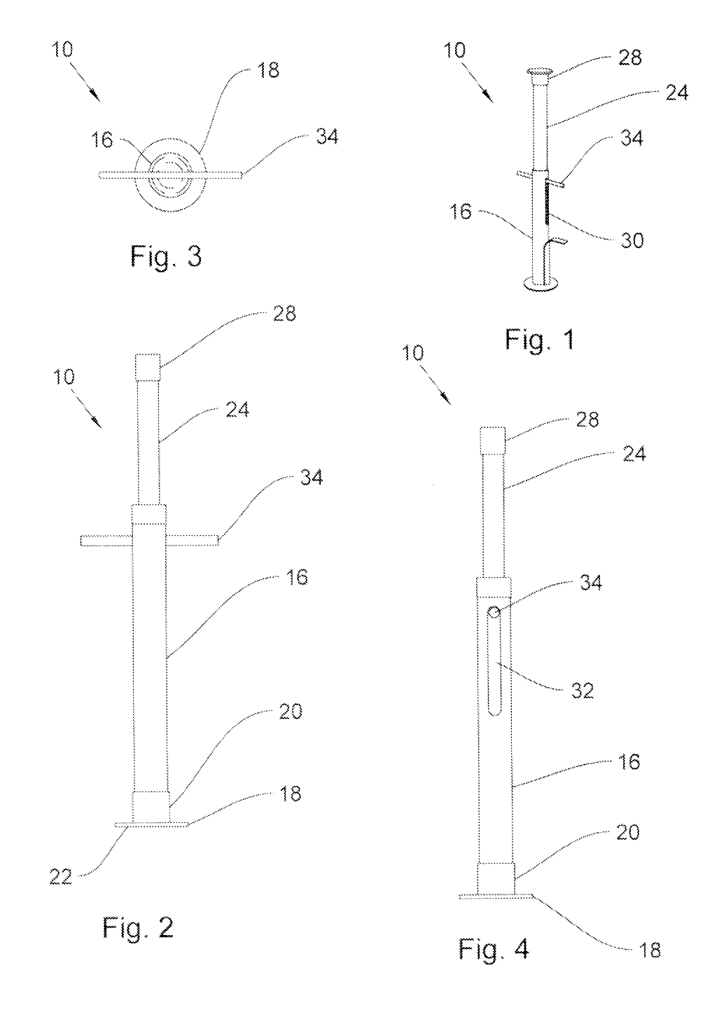

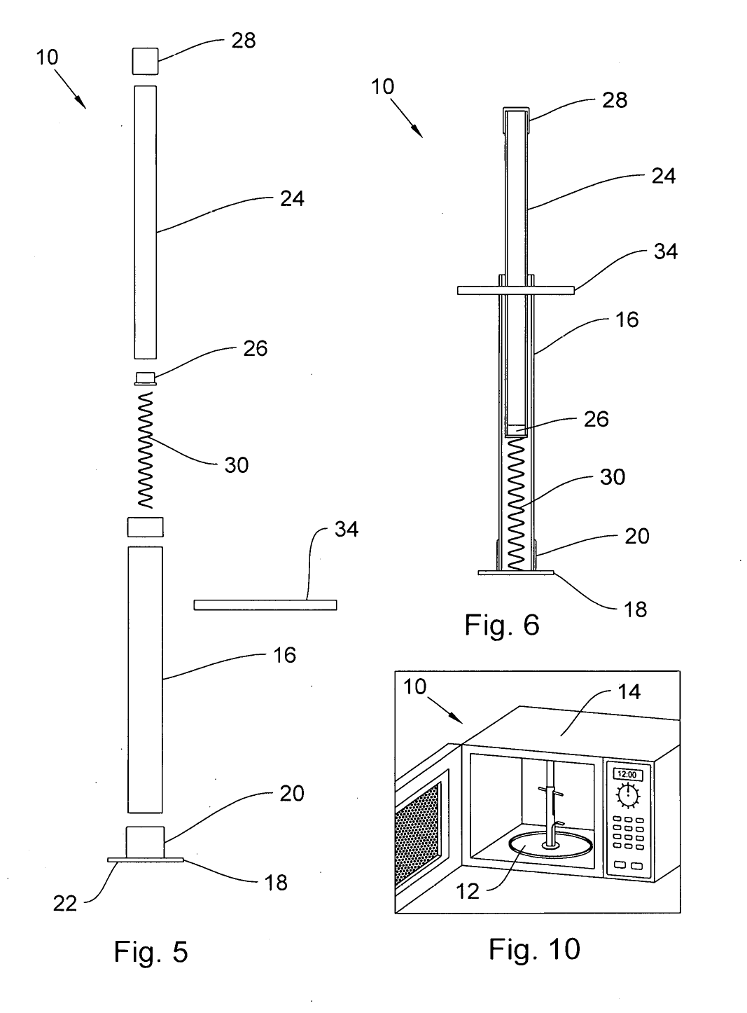

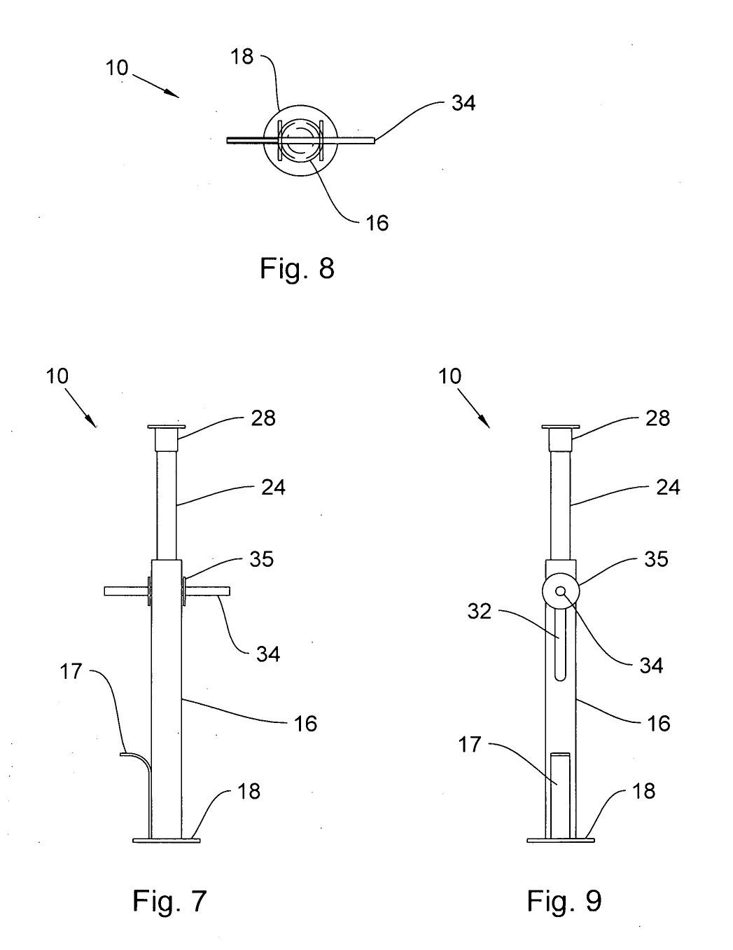

### DETAILED DESCRIPTION OF THE INVENTION

The present invention, hereinafter referred to as a Microwave Oven Turntable Stabilizer Device, indicated generally at 10, is an effective device for stabilizing the glass turntable 12 of a microwave oven 14 in a recreational vehicle or a cruising boat. Constructed to eliminate movement, noise, and breakage, the Microwave Oven Turntable Stabilizer Device 10 protects the glass turntable 12 and makes cruising on land or water more pleasant and trouble free.

The Microwave Oven Turntable Stabilizer Device 10 of the present invention includes an outer support member 16 having a first end and a second end. Preferably, the outer support member 16 is tubular with a diameter of approximately one half (½″) inch although having an outer support member 16 with a diameter greater than or less than one half (½) is within the scope of the present invention. Further a curved handle 17 can mounted to the outer support member nearingly adjacent the first end of the outer support member to assist in the operation of the Microwave Oven Turntable Stabilizer Device 10.

In addition, the Microwave Oven Turntable Stabilizer Device 10 of the present invention has a base plate 18 having a top surface and a bottom surface. In an embodiment of the present invention, the second end of the outer support member 16 is mounted directly to the top surface of base plate 18. In other embodiment, a collar 20 is mounted on the top surface of the base plate 18 with the second end of the outer support member 16 slidably mounted within the collar 20 and releasably held therein by friction or other mechanical means. A resilient pad 22 is mounted to the bottom surface of the base plate 18 thereby cushioning the base plate 18 when the base plate 18 is positioned upon a surface. The base plate 18 preferably has a diameter of approximately one and five-eighths (1⅝″) inches although having a base plate 18 with different dimensions is within the scope of the present invention. The base plate 18 and collar 20 stabilizes the outer support member on a surface during use, as will be described in further detail below.

Additionally, the Microwave Oven Turntable Stabilizer Device 10 of the present invention includes an inner support member 24 having a first end and a second end. The second end of the inner support member 24 is slidably receivable within the first end of the outer support member 16. Preferably, the inner support member 24 is a steel tube measuring approximately three-eighths (⅜″) inch in diameter although having an inner support member 24 with different diameters is within the scope of the present invention. In addition, preferably, a resilient plug 26 is mounted within the second end of the inner support member 24 and a resilient cap 28 is mounted over the first end of the inner support member 24 providing a soft contact between the first end of the inner support member 24 and the microwave 14, as will be described in further detail below.

The Microwave Oven Turntable Stabilizer Device 10 of the present invention further includes a spring mechanism 30 mounted between the second end of the outer support member 16 and the second end of the inner support member 24. The spring mechanism 30 is preferably an approximately twelve pound steel compression spring 30 although having a different type of spring mechanism 30 with greater or lesser compression is within the scope of the present invention. In operation, the spring mechanism 30 biases the inner support member 24 in a general direction away from and out of the outer support member 16.

Furthermore, the Microwave Oven Turntable Stabilizer Device 10 of the present invention includes a pair of vertically oriented, aligned opposite slots 32 formed in the outer support member 16 nearingly adjacent the first end of the outer support member 16. Preferably, the slots 32 measure approximately two and one eighth (2⅛″) inches in height by one-eighth (⅛″) inch in width although having slots 32 with different dimensions are within the scope of the present invention.

The Microwave Oven Turntable Stabilizer Device 10 of the present invention additionally includes a steel cross rod 34 extending through the inner support member 24 and the pair of slots 32 and extending beyond an outer surface of the outer support member 16. In an embodiment of the present invention, the cross rod 34 includes a washer stop 35 mounted outside each slot 32 to keep the cross rod 34 from moving relative to the outer support member 16. Preferably, the cross rod 34 measures approximately three (3″) inches in length by three-sixteenths ( 3/16″) inch in thickness although having a cross rod 34 with different dimensions is within the scope of the present invention. The device of the present invention can be made of composite materials.

Pressing down on the cross rod 34 of the Microwave Oven Turntable Stabilizer Device 10 of the present invention forces the inner support member 24 against the bias of the spring mechanism 30. As the inner support member 24 is retracted into the outer support member 16, the Microwave Oven Turntable Stabilizer Device 10 shortens, making it easy to position the Microwave Turntable Stabilizer Device 10 in the center of the microwave oven 14.

A spring loaded device padded at each end, the Microwave Oven Turntable Stabilizer Device 10 of the present invention fits into a microwave oven 14 and stands as a spring tensioned pillar between the glass turntable 12 and ceiling of the microwave oven 14, immobilizing and securing the turntable 12 against vibration, noise and breakage during the course of RV or boat travel. After positioning the Microwave Oven Turntable Stabilizer Device 10, a user releases downward pressure on the cross rod 34 in a controlled and gradual manner, allowing the Microwave Oven Turntable Stabilizer Device 10 to extend itself between the microwave turntable 12 and the oven ceiling. At full extension, the base plate 18 presses downward on the microwave turntable 12 the second end of the inner support member 24 presses upward against the ceiling of the microwave oven 14. The Microwave Oven Turntable Stabilizer Device 10 attains a maximum extension height of preferably approximately nine and nine-sixteenth (9 9/16″) inches. With spring loaded capability, the Microwave Oven Turntable Stabilizer Device 10 can accommodate microwave ovens 14 of lesser interior height than the aforementioned maximum extension height.

The Microwave Oven Turntable Stabilizer Device 10 of the present invention stabilizes and protects the turntable and interior of the microwave oven 14, and also eliminates a need to repeatedly remove the turntable 12 and its supporting ring and pack them securely for the day's travel. Firmly securing a turntable 12 within a microwave oven 14, the Microwave Oven Turntable Stabilizer Device 10 resolves an ongoing challenge of how to quietly store a turntable 12 while preventing dislodgement and breakage of the turntable 12. Durably constructed and made with high quality materials, the present invention will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A microwave oven turntable stabilizer device for stabilizing a glass turntable of a microwave oven, the microwave oven having a ceiling surface, the microwave oven turntable stabilizer device comprising:
a tubular outer support member having a first end and a second end;
an inner support member having a first end and a second end, the second end of the inner support member slidably receivable within the first end of the outer support member; and
a spring mechanism mounted between the second end of the outer support member and the second end of the inner support member, the spring mechanism biasing the inner support member in a general direction away from and out of the outer support member;
wherein upon the combined outer support member and inner support member being positioned between the microwave turntable and the ceiling surface of the microwave, the microwave turntable is stabilized preventing movement, noise, and breakage of the microwave turntable.

2. The microwave oven turntable stabilizer device of claim 1 and further comprising:
a base plate having a top surface and a bottom surface;
wherein the second end of outer support member is mounted to the top surface of the base plate.

3. The microwave oven turntable stabilizer device of claim 1 and further comprising:
a base plate having a top surface and a bottom surface; and
a collar mounted on the top surface of the base plate;
wherein the second end of the outer support member is slidably mountable within the collar.

4. The microwave oven turntable stabilizer device of claim 2 and further comprising:
a resilient pad mounted to the bottom surface of the base plate.

5. The microwave oven turntable stabilizer device of claim 1 and further comprising:
a resilient plug mounted within the second end of the inner support member.

6. The microwave oven turntable stabilizer device of claim 1 and further comprising:
a resilient cap mounted over the first end of the inner support member.

7. The microwave oven turntable stabilizer device of claim 1 wherein the spring mechanism is a steel compression spring.

8. The microwave oven turntable stabilizer device of claim 1 and further comprising:
a pair of vertically oriented, aligned opposite slots formed in the outer support member nearingly adjacent the first end of the outer support member.

9. The microwave oven turntable stabilizer device of claim 8 and further comprising:
a cross rod extending through the inner support member and the pair of slots and extending beyond an outer surface of the outer support member;
wherein pressing down on the rod forces the inner support member against the bias of the spring mechanism.

10. The microwave oven turntable stabilizer device of claim 9 and further comprising:
a washer stop mounted outside each slot to maintain the position of the cross rod relative to the outer support member.

11. The microwave oven turntable stabilizer device of claim 1 and further comprising:
a curved handle mounted to the outer support member nearingly adjacent the first end of the outer support member.

12. A method for stabilizing a glass turntable of a microwave oven, the microwave oven having a ceiling surface, the method comprising:
providing a tubular outer support member having a first end and a second end;
providing an inner support member having a first end and a second end;
sliding the second end of the inner support member into the first end of the outer support member;
mounting a spring mechanism between the second end of the outer support member and the second end of the inner support member;
biasing the inner support member in a general direction away from and out of the outer support member;
positioning the combined outer support member and inner support member between the microwave turntable and the ceiling surface of the microwave;
stabilizing the microwave turntable; and
preventing movement, noise, and breakage of the microwave turntable.

13. A microwave oven turntable stabilizer device for stabilizing a glass turntable of a microwave oven, the microwave oven having a ceiling surface, the microwave oven turntable stabilizer device comprising:
a tubular outer support member having a first end and a second end;
an inner support member having a first end and a second end, the second end of the inner support member slidably receivable within the first end of the outer support member;
a compression spring mechanism mounted between the second end of the outer support member and the second end of the inner support member, the spring mechanism biasing the inner support member in a general direction away from and out of the outer support member;
a pair of vertically oriented, aligned opposite slots formed in the outer support member nearingly adjacent the first end of the outer support member;
a cross rod extending through the inner support member and the pair of slots and extending beyond an outer surface of the outer support member;
wherein pressing down on the rod forces the inner support member against the bias of the spring mechanism; and
wherein upon the combined outer support member and inner support member being positioned between the microwave turntable and the ceiling surface of the microwave, the microwave turntable is stabilized preventing movement, noise, and breakage of the microwave turntable.

14. The microwave oven turntable stabilizer device of claim 13 and further comprising:
a base plate having a top surface and a bottom surface;
wherein the second end of outer support member is mounted to the top surface of the base plate.

15. The microwave oven turntable stabilizer device of claim 13 and further comprising:
a base plate having a top surface and a bottom surface; and
a collar mounted on the top surface of the base plate;
wherein the second end of the outer support member is slidably mountable within the collar.

16. The microwave oven turntable stabilizer device of claim 13 and further comprising:
a resilient pad mounted to the bottom surface of the base plate.

17. The microwave oven turntable stabilizer device of claim 13 and further comprising:
a resilient plug mounted within the second end of the inner support member.

18. The microwave oven turntable stabilizer device of claim 13 and further comprising:
a resilient cap mounted over the first end of the inner support member.

19. The microwave oven turntable stabilizer device of claim 13 and further comprising:
a washer stop mounted outside each slot to maintain the position of the cross rod relative to the outer support member.

20. The microwave oven turntable stabilizer device of claim 13 and further comprising:
a curved handle mounted to the outer support member nearingly adjacent the first end of the outer support member.
